(19) United States
(12) Patent Application Publication
(10) Pub. No.: US 2014/0036619 A1
(43) Pub. Date: Feb. 6, 2014

(54) MULTI-ANGLE SCREW TOP

(71) Applicant: Patz Corporation, Pound, WI (US)

(72) Inventors: David C. PELLMAN, Coleman, WI (US); Dan JOHNSTON, Porterfield, WI (US)

(73) Assignee: Patz Corporation, Pound, WI (US)

(21) Appl. No.: 13/955,381

(22) Filed: Jul. 31, 2013

Related U.S. Application Data
(60) Provisional application No. 61/677,916, filed on Jul. 31, 2012.

(51) Int. Cl. B01F 7/00

(52) U.S. Cl. CPC B01F 7/00416
USPC 366/343

(57) ABSTRACT

A material processing machine having a rotating element formed of a core rotatable about a generally vertical axis, and a top cap having a pair of facets which abut together at a join line. The join line extends downward from perpendicular to the generally vertical axis at an angle. The core has a continuous outer wall that is substantially vertical, and the facets extend inward from the outer wall to the join line at a non-perpendicular angle. Each of the facets extends inward from the outer wall to the join line at an angle that is different from angle of the other facet.

### CROSS REFERENCE TO RELATED APPLICATION

This application claims the benefit of U.S. Provisional Patent Application Ser. No. 61/677,916, filed on Jul. 31, 2012, the disclosure of which is incorporated herein by reference in its entirety.

### BACKGROUND

Conventional vertical material processing machines used in, for example, the agricultural industry for feed chopping and mixing may include one or more vertically oriented rotating elements or screws having disc-like elements or flighting extending from the rotating elements. The rotating elements or screws may have a core to which the flighting may be attached, with the core being cylindrical in nature and have a cap to prevent material from entering within the core. When baled or compacted material is placed within the machine, some of the baled or compacted material may rest on top of the cap. It is desirable to have a cap that helps prevent the material placed in the machine from remaining on top of the core.

With larger bales or other forms of compacted materials that are placed in the vertical mixing machine, it is possible that the bale may bridge from the top of the core to the side of a mixing tub in which the screw is positioned. It is desirable to have a cap on the top of the core of the screw, with the cap configured to aid the breaking of the bale or compacted material and remove the bridge so that the material can fall into the tub and be engaged by the mixing screw.

Conventional designs and configurations of tops of vertical mixing screws have included a single flat plane, or a single inclined plane, or a cone with the apex centered with the core axis, as an upper surface of the cap. This conventional design is still susceptible to having feed material build up on the top of the cap and not fall into the tub, and will not aid the breaking of the bale or compacted material and removing or dislodging the bridge so that the material can fall into the tub and be engaged by the mixing screw. The rotational speed of the screw moving within the vertical feed mixer is typically not enough to provide adequate force to dislodge the material built up on the top cap. One conventional approach to dislodging the built up material is to simply run the mixer screw faster. But there are practical limits to which the rotational speed may be raised. Another alternative conventional solution is for a user to simply reach into the mixer and dislodge the material while the mixer is running, or stopping the screw's rotation before physically dislodging the material This approach might create safety or operational issues that would preferably be avoided.

Improvements to these types of vertical mixing machines are desirable.

### SUMMARY OF THE INVENTION

The invention provides a material processing machine having a rotating element formed of a core rotatable about a generally vertical axis, and a top cap having a pair of facets which abut together at a join line. The join line extends downward from perpendicular to the generally vertical axis. The core has a continuous outer wall that is substantially vertical, and the facets extend inward from the outer wall to the join line at a non-perpendicular angle. Each of the facets may extend inward from the outer wall to the join line at an angle that is different from angle of the other facet.

Other objects and advantages of the invention will become apparent hereinafter.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a perspective view of vertical mixing screw according to the present disclosure with the top cap removed.

FIG. 2 is a side view of the vertical mixing screw of FIG. 1.

FIG. 3 is a top view of the vertical mixing screw of FIG. 1.

FIG. 4 is a side cross-sectional view of the vertical mixing screw of FIG. 1.

FIG. 5 is a perspective view of the core of the vertical mixing screw of FIG. 1, with top cap in place.

FIG. 6 is a top view of the core with top cap of FIG. 5.

FIG. 7 is a side view of the core with top cap of FIG. 5.

FIG. 8 is an oblique side view of the core with top cap of FIG. 5, taken along line A-A in FIG. 5.

FIG. 9 is a perspective view of the top cap of FIG. 5.

FIG. 10 is a top view of a core similar to FIG. 6, but with a different embodiment of a top cap.

FIG. 11 is a perspective view of the core with the cap shown in FIG. 10.

### DETAILED DESCRIPTION

Reference will now be made to exemplary aspects of the present invention which are illustrated in the accompanying drawings. Wherever possible, the same reference numbers will be used throughout the drawings to refer to the same or like parts.

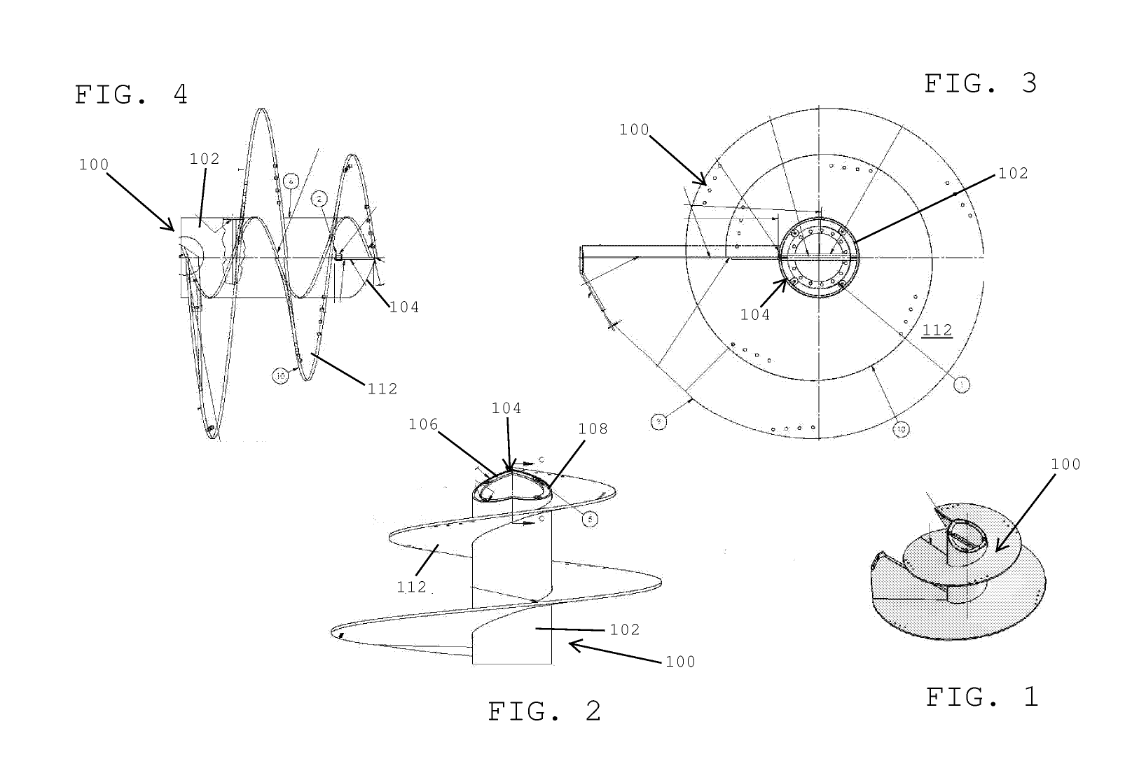

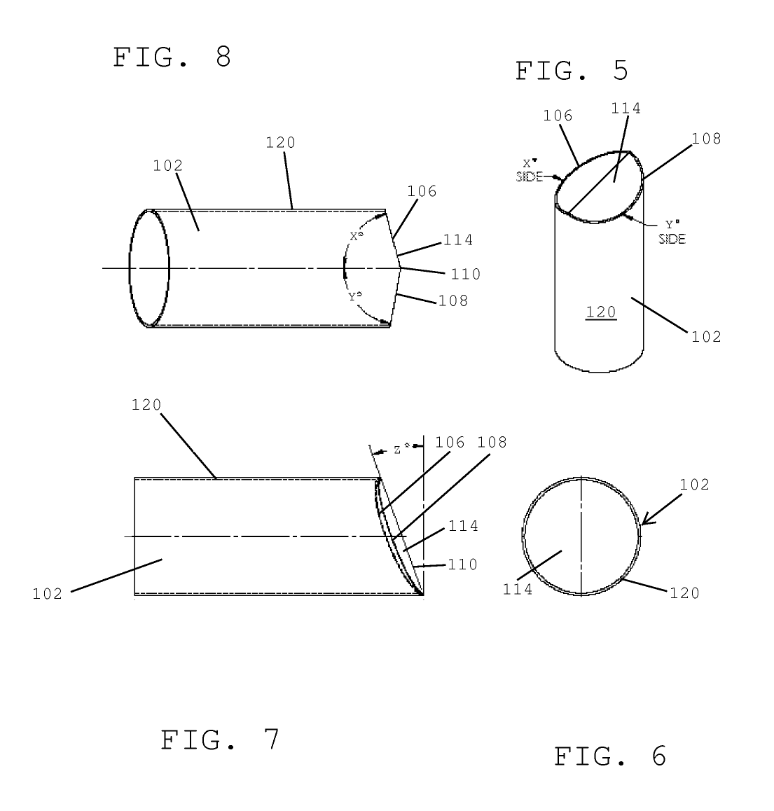

FIGS. 1 to 4 illustrate a vertical mixing screw 100 according to the present disclosure that is configured with a core 102 having an angled top 104. Angled top 104 is shown without a top cap in place and includes a first side 106 and a second side 108. Vertical mixing screw 100 may include flighting 112 positioned about central core 102. In normal practice, a top cap would be positioned on top of core 102 to close angled top 104. According to the invention, preferably the top cap would at least include two facets or inclined planes corresponding to the angle shape of top 104 to define a top cap with at least two facets.

Rather than having a top cap with single upper surface, whether or not inclined from the horizontal, as would be conventional, the top cap of the present disclosure would have at least a pair of facets in the top cap, which are joined along a join line 110 between the two facets.

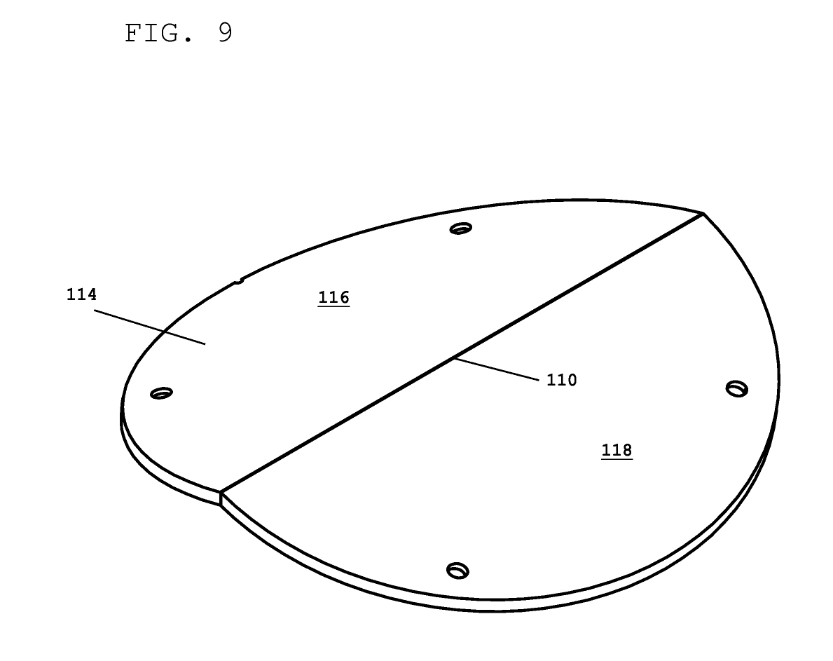

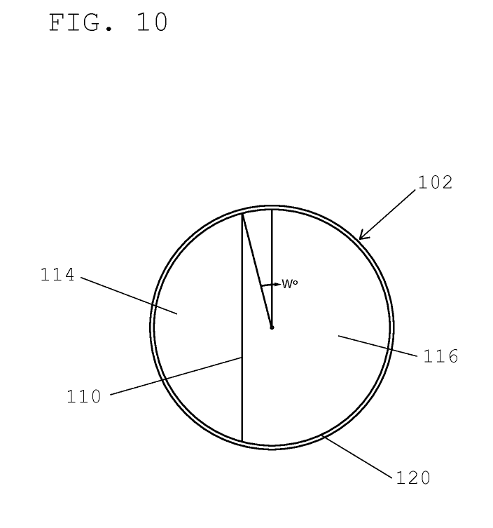

FIGS. 5 to 8 illustrate core 102 with flighting 112 removed or not yet applied. Core 102 may have an angled top cap 114 with a first side 116 and a second side 118, corresponding to first side 106 and second side 108. As shown, sides 106 and 108, and sides 116 and 118, may be angled at differing degrees from one side to the other side. As shown in FIG. 7, the join line is positioned at a join line angle Z from the horizontal. The join line angle Z shown is about 20 degrees, but other join line angles may work in addition. As shown in FIG. 8, the facets also angle generally non-perpendicularly from the side wall 120, at top angles X and Y respectively. The most preferable angle for top angles X and Y from the side wall 120 is about 75 to about 80 degrees. The added angular configuration provides for greater impetus for material on top of the top cap to be dislodged from the top cap when the screw is rotated within the vertical feed mixer. Top angles X and Y are illustrated as, but not limited to 75 degrees and 80 degrees, respectively, from the side wall 120. It is anticipated that the top angles could be symmetrical, that is, be angled the same toward both sides. Greater or smaller angles may be used for the top angles within the scope of the present disclosure.

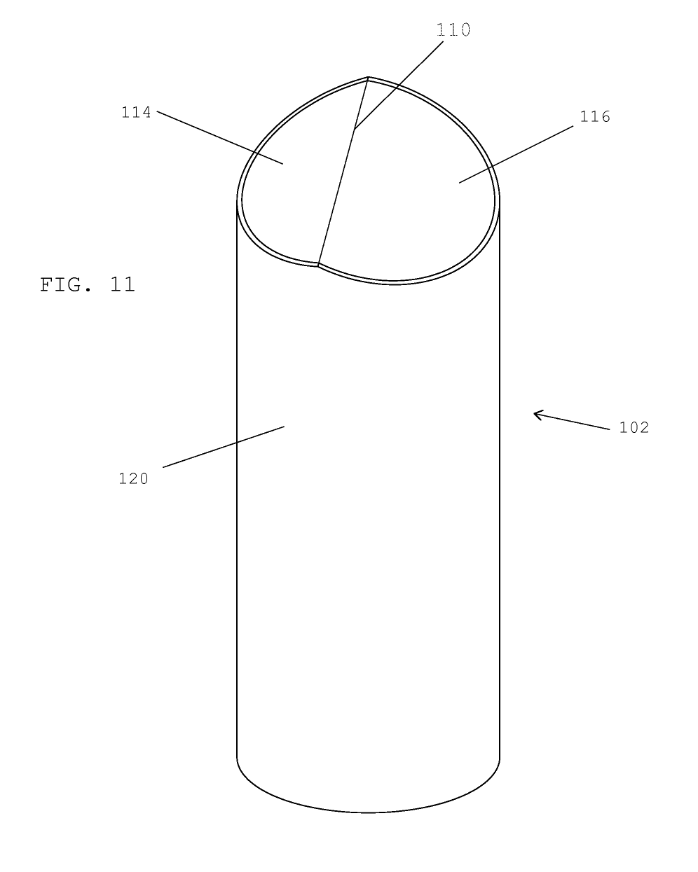

FIG. 9 illustrates top cap 114 removed from core 102.

Further, as shown in FIG. 10, join line 110 need not be diametrical with respect to the core 102, but rather, may also be a non-diametrical chord. Each side 106 and 108, however, must not be insubstantial in comparison to the other. That is, assuming the join line 110 is a non-diametrical chord as with the embodiment shown in FIGS. 10-11, the angle W between the radial line that is parallel to the chord and the radial line to the nearest endpoint of the chord should not exceed 30 degrees.

The values for the join line angle Z and the top angles X and Y are illustrative only and greater or smaller angles may be used within the scope of the present disclosure. A greater join line angle may allow shallower side angles to be used and vice versa. The nature of the materials to be introduced into the vertical mixer may also influence the angles selected for the join line angle and for the top angles. Some materials and/or compaction techniques may permit shallower angles to be used, while other materials and/or compaction techniques may suggest the use of greater angles to more effectively dislodge material from the top cap at normal operating speeds.

While the present disclosure illustrates flighting and core which are formed separately and joined, as well as a top cap that is formed separately and joined to form the vertical mixing screw, it is anticipated that one or more elements may be integrally formed or that the parts described herein may be assembled from a plurality of smaller constituent parts.

It is further anticipated that a top cap may have more than two angled facets, and more than one join line, and still be within the scope of the present disclosure.

While the invention has been described with reference to preferred embodiments, it is to be understood that the invention is not intended to be limited to the specific embodiments set forth above. Certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A material processing machine comprising:
a rotating element having a core rotatable about a generally vertical axis,
the core having a top cap having a plurality of angled facets.

2. A material processing machine as recited in claim 1, wherein the top cap has a pair of facets which abut together at a join line.

3. A material processing machine as recited in claim 2, wherein the join line extends downward from perpendicular to the generally vertical axis at a join line angle.

4. A material processing machine as recited in claim 3 wherein the join line angle is about 20 degrees.

5. A material processing machine as recited in claim 3 wherein the core has a continuous outer wall that is substantially vertical, and wherein the facets extend inward from the outer wall to the join line at a non-perpendicular angle.

6. A material processing machine as recited in claim 5 wherein the non-perpendicular angle is about 75 to 80 degrees.

7. A material processing machine as recited in claim 3 wherein each of the facets extends inward from the outer wall to the join line at an angle that is different from angle of the other facet.

8. A material processing machine as recited in claim 6 further comprising flighting applied about the outer wall.

9. A rotating element for use in a material processing machine, the rotating element comprising:
a core having a top end and being rotatable about an axis that is generally vertically oriented;
a top cap connected with the top end, the top cap having a plurality of angled facets.

10. A material processing machine as recited in claim 9, wherein the top cap has a pair of facets which abut together at a join line.

11. A material processing machine as recited in claim 10, wherein the join line extends downward from perpendicular to the generally vertical axis at a join line angle.

12. A material processing machine as recited in claim 11 wherein the join line angle is about 20 degrees.

13. A material processing machine as recited in claim 10 wherein the core has a continuous outer wall that is substantially vertical, and wherein the facets extend inward from the outer wall to the join line at a non-perpendicular angle

14. A material processing machine as recited in claim 13 wherein the non-perpendicular angle is about 75 to 80 degrees.

15. A material processing machine as recited in claim 10 wherein each of the facets extends inward from the outer wall to the join line at an angle that is different from angle of the other facet.

16. A material processing machine as recited in claim 14 further comprising flighting applied about the outer wall.
